(19) United States
(12) Patent Application Publication
(10) Pub. No.: US 2026/0186233 A1
(43) Pub. Date: Jul. 2, 2026

(54) LENS DRIVING DEVICE

(71) Applicant: AAC Microtech (Changzhou) Co., Ltd., Changzhou City (CN)

(72) Inventors: Bo Xiao, Changzhou (CN); Tong Zhang, Changzhou (CN); Ronglin Linghu, Changzhou (CN); Wei Song, Changzhou (CN); Zhang Ren, Changzhou (CN)

(21) Appl. No.: 19/299,314

(22) Filed: Aug. 13, 2025

Related U.S. Application Data
(63) Continuation of application No. PCT/CN2025/070193, filed on Jan. 2, 2025.

(51) Int. Cl. G02B 7/04; G02B 27/64

(52) U.S. Cl. CPC G02B 7/04; G02B 27/646

(57) ABSTRACT

The present application provides a lens driving device, including a lens module having an optical axis; a housing including a base plate and an upper cover; a first support frame elastically supported on the base plate, a second support frame elastically supported on the first support frame and configured to mount the lens module; a first driving assembly configured to drive the second support frame to move along an axis direction parallel to the optical axis of the light-transmitting aperture, and a second driving assembly configured to drive the second support frame to move along a direction perpendicular to the axis direction. The upper cover includes a top wall and a peripheral wall, with the periphery of the top wall featuring a clearance platform recessed toward the base plate. The lens driving device of the present application allows the decorative member to fully cover the lens driving device.

### CROSS-REFERENCE TO RELATED APPLICATIONS

This application is a continuation of International Application No. PCT/CN 2025/070193, Jan. 2, 2025, the entire contents of which are incorporated herein by reference.

### TECHNICAL FIELD

The present application relates to the field of photographic equipment technologies, in particular to a lens driving device.

### BACKGROUND

With the improvement of living standards, electronic devices with photographic capabilities, such as digital cameras, camcorders, smartphones, and tablets, are now commonly equipped with autofocus cameras. These autofocus cameras require lens driving devices to achieve automatic focus adjustment and optical image stabilization.

The lens driving device mainly includes a housing, a first support frame, a second support frame spaced apart from the first support frame, a first driving assembly for moving the lens module along its optical axis, and a second driving assembly for moving the lens module perpendicular to the optical axis.

In the related art, the housing includes a base plate and a top cover fixed to the base plate, both of which are flat in structure. When the lens driving device is applied to an electronic device, due to the design of the electronic device and the flat design of the upper cover, decorative components on the lens may sometimes fail to fully cover the lens driving device. In such cases, to ensure complete coverage of the lens driving device, the thickness of the outer casing of the electronic device needs to be increased.

### SUMMARY

The present application provides a lens driving device aimed at addressing the issue in related art where, after the lens driving device is applied to electronic devices, the decorative components cannot fully cover the lens driving device, thereby requiring an increase in the thickness of the outer casing of the electronic device to ensure the decorative components fully cover the lens driving device.

In a first aspect, the present application provides a lens driving device including:
a lens module having an optical axis;
a housing including:
   a base plate; and
   a cover plate disposed on the base plate and forming an accommodating space with the base plate, the cover plate having a light-transmitting hole disposed opposite the lens module;
a first support frame, which is ring-shaped, elastically supported on the base plate, and located within the accommodating space;
a second support frame configured to mount the lens module, elastically supported on and located inside the first support frame at an interval;
a first driving assembly configured to drive the second support frame to move the lens module relative to the first support frame along an axis direction parallel to the optical axis, and including a first magnetic circuit system fixed to the first support frame and a driving coil fixed to the second support frame; and
a second driving assembly configured to drive the first support frame to move the second support frame and the lens module relative to the base plate along a direction perpendicular to the axis direction, and including a second magnetic circuit system and an anti-vibration coil spaced apart from the second magnetic circuit system, wherein the second magnetic circuit system is fixed to one of the base plate and the first support frame, and the anti-vibration coil is fixed to the other of the base plate and the first support frame;
wherein the upper cover includes a top wall opposite and spaced apart from the base plate along the axis direction, and a peripheral wall bent and extended from a periphery of the top wall toward the base plate and fixedly connected to the base plate, the periphery of the top wall is provided with a clearance platform recessed toward the base plate along the axis direction.

As an improvement, the housing and the first support frame are both rectangular; the clearance platform is located a corner position of the top wall, and the clearance platform is spaced apart from the first driving assembly along the axis direction.

As an improvement, the lens driving device further includes a damping assembly disposed between the top wall and the first support frame, the top wall is provided with at least two clearance platforms arranged opposite to the damping assembly along the axis direction.

As an improvement, the lens driving device includes two first driving assemblies correspondingly provided at one set of diagonal positions on the first support frame, the top wall is provided with at least three clearance platforms.

As an improvement, the lens driving device further includes two damping assemblies correspondingly provided at the other set of diagonal positions on the first support frame.

As an improvement, the damping assembly includes a damping adhesive fixed to the first support frame and a damping member fixed to a side of the clearance platform facing the first support frame; and the damping member is inserted into the damping adhesive.

As an improvement, a corner position of the first support frame corresponding to the damping assembly is provided with a recess depressed inwardly, and the damping adhesive is accommodated within the recess.

As an improvement, the lens driving device further includes a first elastic member for elastically supporting the second support frame within the first support frame, the first elastic member includes a first fixing arm fixed to the second support frame, a second fixing arm fixed to the first support frame, and an elastic arm extending from the first fixing arm to be fixedly connected with the second fixing arm, the first elastic member is malposed with the clearance platform along the axis direction.

As an improvement, the second magnetic circuit system is fixed to the base plate, the anti-vibration coil is fixed to a side of the first support frame away from the top wall along the axis direction and is opposite to the second magnetic circuit system, the anti-vibration coil and the damping assembly are oppositely arranged along the axis direction.

As an improvement, the second driving assembly includes an anti-collision spacer disposed on a side of the anti-vibration coil facing the second magnetic circuit system, and the anti-collision spacer is spaced apart from the second magnetic circuit system along the axis direction.

Compared with the related art, the lens driving device of the present application provides a clearance platform recessed toward the bottom plate along the periphery of the top wall, which is opposite and spaced apart from the bottom plate, and the recessed direction of the clearance platform is parallel to the axis direction. When the lens driving device is applied to an electronic device, the clearance platform can be aligned with a position that cannot be covered by the decorative component, thereby achieving the effect of the decorative component completely covering the lens driving device. This avoids the issue of increasing the thickness of the outer casing of the electronic device to ensure the decorative component fully covers the lens driving device.

### BRIEF DESCRIPTION OF THE DRAWINGS

To more clearly illustrate the technical solutions in the embodiments of the present application or the related art, the drawings required in the description of the embodiments or related technologies will be briefly introduced in the following. Obviously, the drawings described below are merely some embodiments of the present application. For those skilled in the art, other drawings may be obtained based on these drawings without involving creative labor.

FIG. 1 is a three-dimensional structural schematic diagram of a lens driving device according to Embodiment 1 of the present application.

FIG. 2 is a partial exploded view of the lens driving device according to Embodiment 1 of the present application.

FIG. 3 is a cross-sectional view taken along line A-A in FIG. 1.

FIG. 4 is a cross-sectional view taken along line B-B in FIG. 1.

FIG. 5 is a three-dimensional structural schematic diagram of the lens driving device according to Embodiment 2 of the present application.

FIG. 6 is a three-dimensional structural schematic diagram of the lens driving device according to Embodiment 3 of the present application.

FIG. 7 is a three-dimensional structural schematic diagram of the lens driving device according to Embodiment 4 of the present application.

FIG. 8 is a three-dimensional structural schematic diagram of an electronic device according to Embodiment 5 of the present application.

FIG. 9 is a partial exploded view of the electronic device according to Embodiment 5 of the present application.

In the figures, 100, lens driving device; 101, lens module; 1, housing; 10, accommodating space; 11, base plate; 12, upper cover; 121, top wall; 1211, clearance platform; 122, peripheral wall; 13, light-transmitting hole; 2, first support frame; 21, recess; 3: second support frame; 31, clamping arm; 4, first driving assembly; 41, first magnetic circuit system; 411, magnetic bowl; 4111, bowl bottom; 4112, side wall; 412, magnet assembly; 4121, first driving magnet; 4122, pole core; 4123, second driving magnet; 413, upper clamping plate; 42, driving coil; 5, second driving assembly; 51, second magnetic circuit system; 511, lower clamping plate; 512, first anti-vibration magnet; 513, second anti-vibration magnet; 514, third anti-vibration magnet; 52, anti-collision spacer; 53, anti-vibration coil; 6, damping assembly; 61, damping adhesive; 62, damping assembly; 7, first elastic member; 71, first fixing arm; 72, second fixing arm; 73, elastic arm; 8, second elastic member; 9, third elastic member; 10, flexible circuit board.
200, electronic device; 201, outer casing; and 202, transparent decorative component.

### DETAILED DESCRIPTION OF THE EMBODIMENTS

To make the objectives, technical solutions, and advantages of the present application clearer, the following detailed description is provided with reference to the accompanying drawings and embodiments. It should be understood that the specific embodiments described herein are merely used to explain the present application and are not intended to limit the scope of the present application.

### Embodiment 1

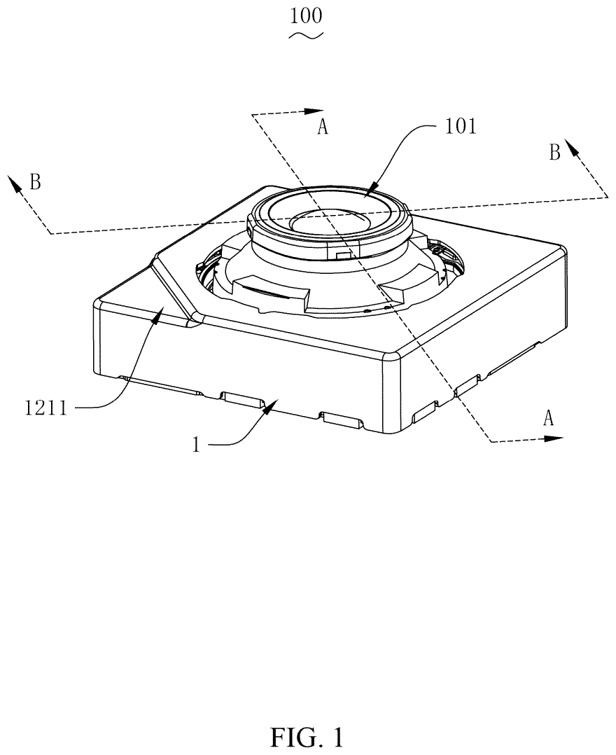

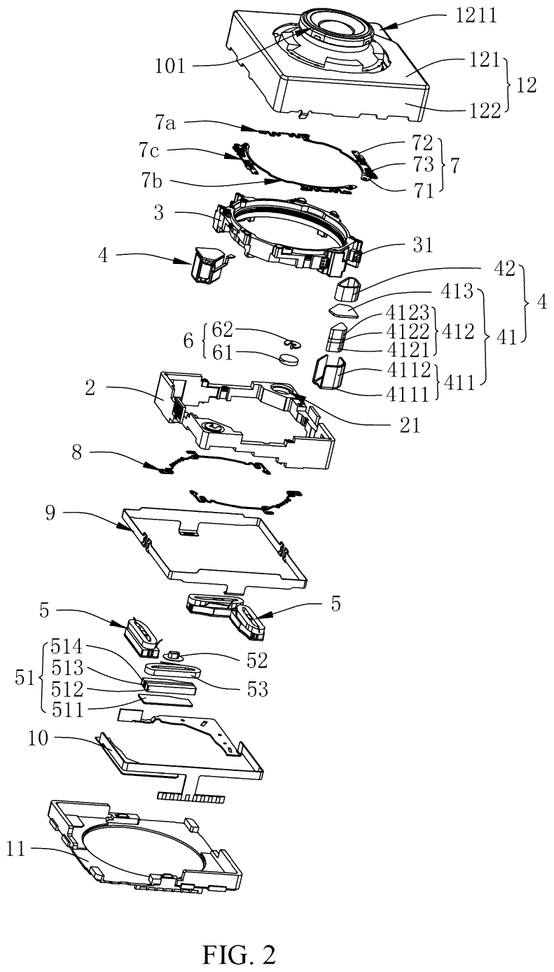

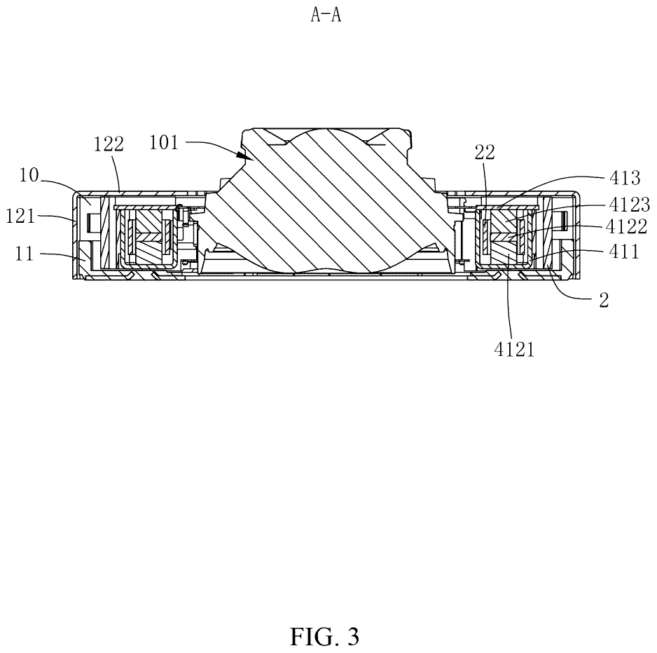

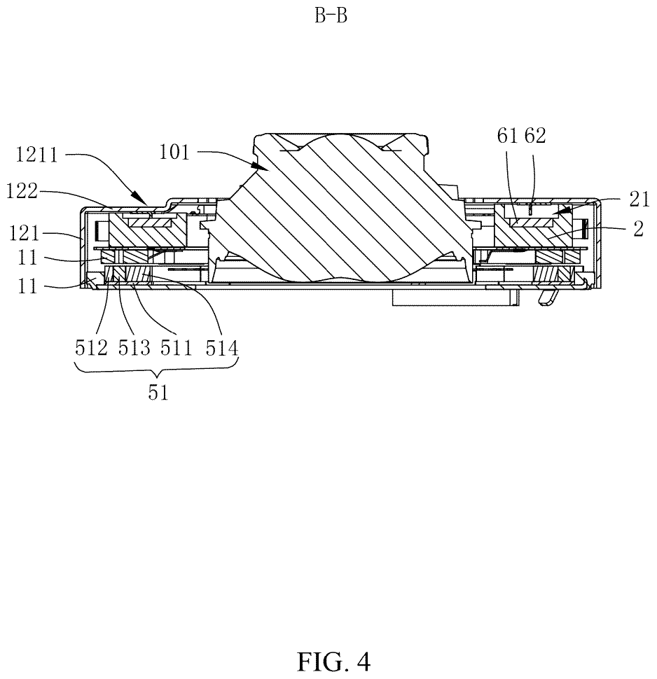

As shown in FIGS. 1 to 4, the present application provides a lens driving device 100, including a housing 1, a first support frame 2, a second support frame 3, a first driving assembly 4, a second driving assembly 5, and a lens module 101 having an optical axis.

The housing 1 includes a base plate 11 and a cover 12 disposed on the base plate 11 and forms an accommodating space 10 with the base plate 11. The cover 12 has a light-transmitting hole 13 connecting the accommodating space 10 to the outside, and the light-transmitting hole 13 is disposed opposite the lens module 101 along the optical axis of the lens module 101. The first support frame 2, the second support frame 3, the first driving assembly 4, and the second driving assembly 5 are all accommodated within the accommodating space 10, and the lens module 101 is at least partially accommodated within the accommodating space 10.

The upper cover 12 includes a top wall 121 disposed opposite and spaced apart from the bottom plate 11 along the optical axis, and a peripheral wall 122 bent and extended from the periphery of the top wall 121 toward the bottom plate 11 and fixedly connected to the bottom plate 11. The periphery of the top wall 121 is provided with a clearance platform 1211 recessed toward the bottom plate 11 along the axis direction, and the clearance platform 1211 is spaced apart from the first driving assembly 4 along the axis direction.

In this embodiment, the housing 1 and the first support frame 2 are both rectangular. In other embodiments, the housing 1 and the first support frame 2 may also be designed in other shapes, such as circular or trapezoidal.

The clearance platform 1211 is provided at a corner of the top wall 121.

As shown in FIG. 1, in this embodiment, there is one the clearance platform 1211 positioned at any corner position of the top wall 121. The number of clearance platforms 1211 is determined based on the number of areas that need to be cleared after the lens driving device 100 is applied to an electronic device, which may be set to two, three, or four.

In this embodiment, the clearance platform 1211 is triangular in shape. However, according to actual requirements, the clearance platform 1211 may be designed according to the shape of the area that needs to be avoided, such as rectangular or semi-circular.

The first support frame 2 is ring-shaped and elastically supported on the base plate 11.

The second support frame 3 is elastically supported on and located inside the inner side of the first support frame 2 at an interval. The second support frame 3 is aligned with the light-transmitting hole 13 and is configured to install the lens module 101.

In this embodiment, the number of the first driving assemblies 4 is two, and the two first driving assemblies 4 are correspondingly provided at one of the diagonal positions of the first support frame 2. The two first driving assemblies 4 are configured to jointly drive the second support frame 3 to move the lens module 101 relative to the first support frame 2 along the axis direction parallel to the optical axis. In other embodiments, according to actual requirements, the first driving assembly 4 may also be designed as a single unit.

The first driving assembly 4 includes a first magnetic circuit system 41 fixed to the first support frame 2 and a driving coil 42 fixed to the second support frame 3. The first magnetic circuit system 41 includes a magnetic bowl 411 fixed to the first support frame 2, a magnet assembly 412 fixedly stacked inside the magnetic bowl 411, and an upper clamping plate 413 fixedly stacked at an open end of the magnetic bowl 411. The magnetic bowl 411 is provided with two notches on its opposite sides extending along the axis direction of the lens module 101. The driving coil 42 is located inside the magnetic bowl 411 and is arranged around the magnet assembly 412, with a gap between them. The second support frame 3 is provided with two clamping arms 31 extending from the two notches into the magnetic bowl 411, and the two clamping arms 31 are fixedly connected to the driving coil 42.

The magnetic bowl 411 includes a bowl bottom 4111 and a side wall 4112 bent and extended from the peripheral side of the bowl bottom 4111, with the two notches formed in the side wall 4112. The magnet assembly 412 includes a first driving magnet 4121 fixedly stacked at the bowl bottom 4111, a pole core 4122 fixedly stacked at a side of the first driving magnet 4121 away from the bowl bottom 4111, and a second driving magnet 4123 fixedly stacked at a side of the pole core 4122 away from the first driving magnet 4121. The upper clamping plate 413 is fixedly stacked on a side of the second driving magnet 4123 away from the pole core 4122.

The second driving assembly 5 is configured to drive the second support frame 3 to move the first support frame 2 and the lens module 101 relative to the base plate 11 along a direction perpendicular to the optical axis of the lens module 101.

The second driving assembly 5 includes two sets, which are located at the opposite diagonal position of the first support frame 2. Each set of the second driving assembly 5 includes two second driving assemblies 5 located on adjacent sides of the first support frame 2.

The second driving assembly 5 includes a second magnetic circuit system 51, an anti-vibration coil 53 disposed opposite and spaced apart from the second magnetic circuit system 51, and an anti-collision spacer 52 located on a side of the anti-vibration coil 53 facing the second magnetic circuit system 51. The second magnetic circuit system 51 is fixed to one of the base plate 11 and the first support frame 2, while the anti-vibration coil 53 is fixed to the other of the base plate 11 and the first support frame 2. The anti-collision spacer 52 is configured to prevent the anti-vibration coil 53 from colliding with the second magnetic circuit system 51 during a fall.

In this embodiment, the second magnetic circuit system 51 is fixed to the base plate 11, and the anti-vibration coil 53 is fixed to the side of the first support frame 2 away from the top wall 121 along the axis direction.

The second magnetic circuit system 51 includes a lower clamping plate 511 fixed to the base plate 11, and a first anti-vibration magnets 512, a second anti-vibration magnets 513, and a third anti-vibration magnets 514 fixedly stacked at the lower clamping plate 511 and arranged sequentially along the direction perpendicular to the optical axis of the lens module 101. The first anti-vibration magnet 512, the second anti-vibration magnet 513, and the third anti-vibration magnet 514 are mutually fixedly connected.

The lens driving device 100 further includes a damping assembly 6 provided between the top wall 121 and the first support frame 2. The damping assembly 6 is located at the corner adjacent to the first support frame 2 and the first driving assembly 4, and located at a side of the first support frame 2 away from the base plate 11. The damping assembly 6 may be designed with one or two units, configured according to the positions and quantity of areas requiring clearance after the lens driving device 100 is integrated into the electronic equipment. If the clearance platform 1211 corresponds to one corner position adjacent to the first driving assembly 4 on the first support frame 2, then one damping assembly 6 is designed. If the clearance platform 1211 corresponds to two corner positions adjacent to the first driving assembly 4 on the first support frame 2, then two damping assemblies 6 are designed. The two first driving assemblies 4 are correspondingly provided at one set of diagonal positions on the first support frame 2, and the two damping assemblies 6 are correspondingly provided at another set of diagonal positions on the first support frame 2. Specifically, the damping assembly 6 includes a damping adhesive 61 fixed to the first support frame 2 and a damping member 62 fixed to the side of the clearance platform 1211 facing the first support frame 1, with the damping member 62 inserted into the damping adhesive 61. When the lens module 101 moves along a direction perpendicular to the direction of the axis direction, the damping assemblies 6 can absorb additional vibrations, ensuring that the lens driving device 100 has good anti-shake performance and improving image quality.

The first support frame 2 is provided with a recess 21 formed at the corner position corresponding to the damping assembly 6, and the damping adhesive 61 is accommodated within the recess 21. The anti-vibration coil 53 is arranged along the optical axis in correspondence with the damping assembly 6.

In the present application, the first driving assembly 4 is arranged at one set of corners of the first support frame 2, and the damping assembly 6 is arranged at the other corners. Therefore, when the corner position of the top wall 121 of the upper cover 12 needs to be lowered to form a clearance platform 1211, only the corresponding areas of the first driving assembly 4 and/or the damping assembly 6 need to be lowered to provide clearance, without affecting the performance of the lens driving device 100.

The lens driving device 100 further includes a first elastic member 7 for elastically supporting the second support frame 3 within the first support frame 2. The first elastic member 7 is spaced apart from a side of the second support frame 3 away from the base plate 11. The first elastic member 7 includes a first fixing arm 71 fixed to the second support 3, a second fixing arm 72 fixed to the first support 2, and an elastic arm 73 extending from the first fixing arm 71 to be fixedly connected with the second fixing arm 72. The second fixing arm 72 is fixed to a side of the first support 2, and the first elastic member 7 is malposed with the clearance platform 1211 along the axis direction.

In this embodiment, the number of the first elastic member 7 are three. The first first elastic member 7a includes a first fixing arm 71 fixed to the second support 3, two second fixing arms 72 fixed to the first support 2, and an elastic arm 73 extending from both ends of the first fixing arm 71 to the two second fixing arms 72 and forming a fixed connection. The second first elastic member 7b includes a first fixing arm 71 fixed to the second support 3, a second fixing arm 72 fixed to the first support 2, and an elastic arm 73 extending from a middle region of the first fixing arm 71 to the second fixing arm 72 and forming a fixed connection. The third first elastic member 7c includes a first fixing arm 71 fixed to the second support frame 3, a second fixing arm 72 fixed to the first support frame 2, and an elastic arm 73 extending directly from the first fixing arm 71 to the second fixing arm 72 and forming a fixed connection.

The lens driving device 100 further includes four second elastic members 8, which are respectively spaced apart on a side of the first support frame 2 adjacent to the base plate 11. Two ends of each second elastic member 8 are connected to the first support frame 2 and the second support frame 3, respectively, and the structure of the second elastic member 8 is the same as that of the third first elastic member 7.

The lens driving device 100 further includes two third elastic members 9, each of which is elastically connected to the base plate 11 and the first support frame 2.

The lens driving device 100 further includes a flexible circuit board 10, which is fixed to the first support frame 2 and extends from one end to the exterior of the housing 1. The flexible circuit board 10 is electrically connected to all driving coils 42 and all anti-vibration coils 53.

Compared with the related art, the lens driving device 100 of this embodiment provides a clearance platform 1211 recessed toward the bottom plate 11 along the periphery of the top wall 121, which is opposite and spaced apart from the bottom plate 11, and the recessed direction of the clearance platform 1211 is parallel to the axis direction of the lens module 101. When the lens driving device 100 is applied to an electronic device, the clearance platform 1211 can be aligned with a position that cannot be covered by the decorative component, thereby achieving the effect of the decorative component completely covering the lens driving device. This avoids the issue of increasing the thickness of the outer casing of the electronic device to ensure the decorative component fully covers the lens driving device 100.

### Embodiment 2

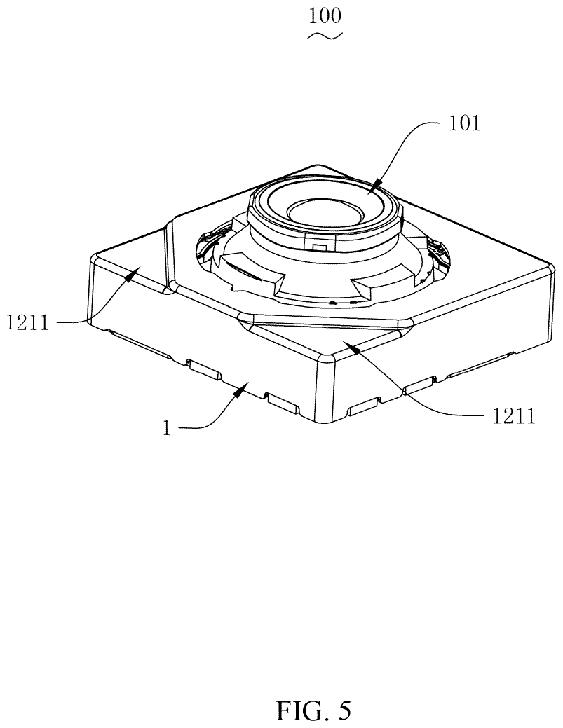

This embodiment differs from Embodiment 1 above in that, as shown in FIG. 5, both adjacent corner positions of the top wall 121 in this embodiment are equipped with clearance platforms 1211.

### Embodiment 3

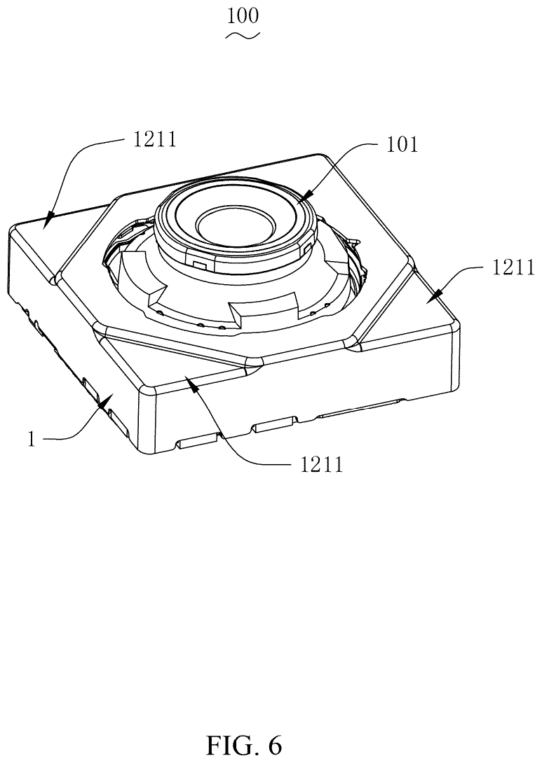

This embodiment differs from Embodiment 1 above in that, as shown in FIG. 6, all three corner positions of the top wall 121 in this embodiment are equipped with clearance platforms 1211.

### Embodiment 4

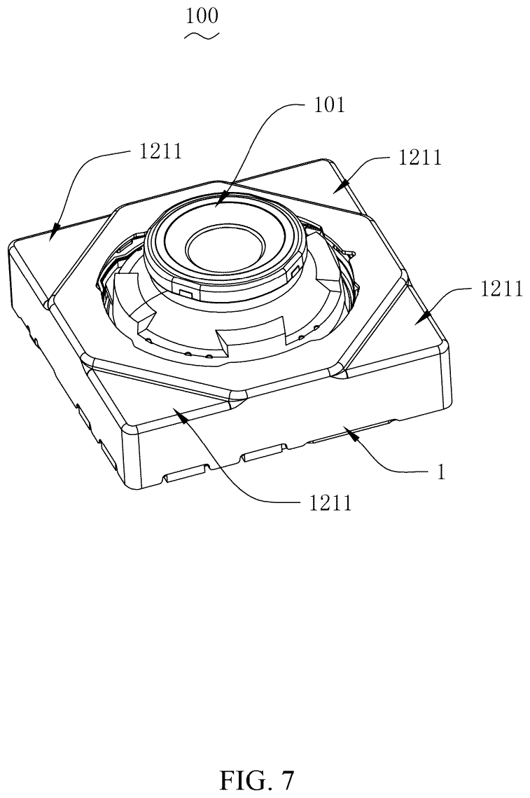

This embodiment differs from Embodiment 1 in that, as shown in FIG. 7, the top wall 121 of this embodiment has clearance platforms 1211 at all four corner positions.

### Embodiment 5

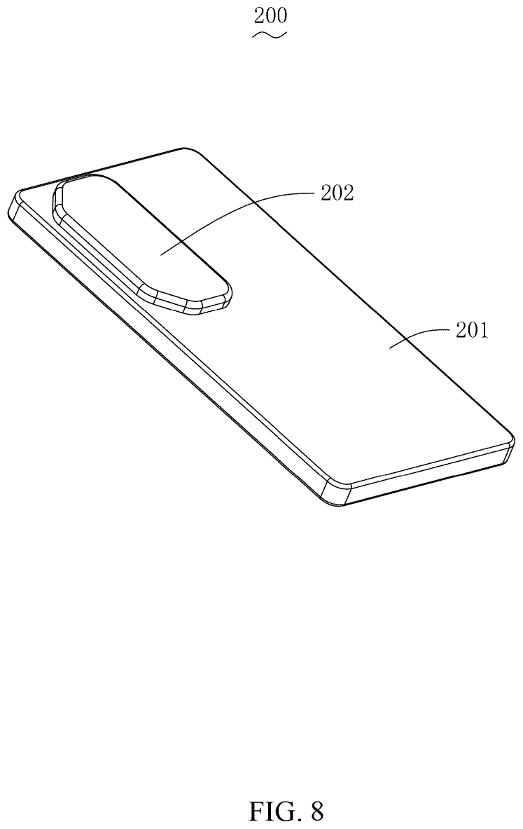

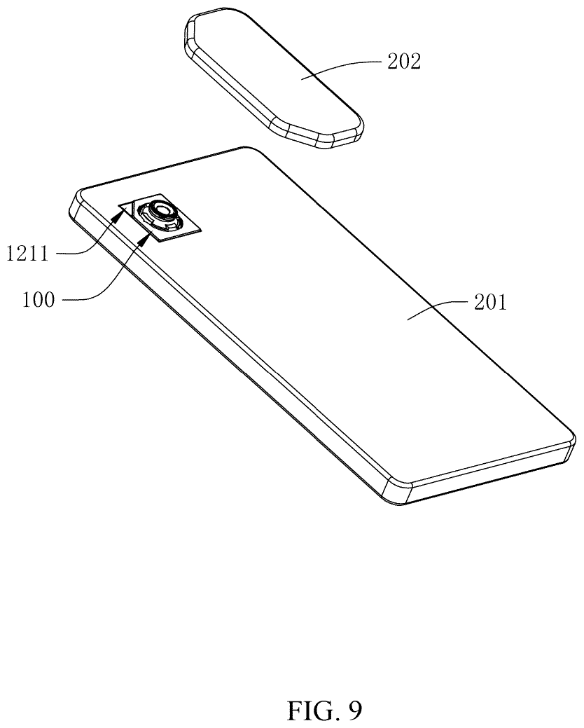

The present application provides an electronic device 200, as shown in FIGS. 8 to 9, including a housing 201, a lens driving device 100 fixed within the housing 201 according to any one of the embodiments from Embodiment 1 to Embodiment 4, and a translucent decorative member 202 fixed over the housing 201 and covering the lens driving device 100, with the translucent decorative member 202 partially fixed over the clearance platforms 1211.

The electronic device 200 is a device with a camera function, such as a mobile phone, tablet computer, or game console.

Since the electronic device 200 in this embodiment includes the lens driving device 100 from any one of the embodiments 1 to 4 described above, it can also achieve the same technical effects as the lens driving device 100 in any one of the embodiments 1 to 4 described above, and further details are omitted here.

Described above are only preferred embodiments of the present application and are not intended to limit the scope of the present application. Any modifications, equivalent replacements, and improvements made within the spirit and principles of the present application should be included within the scope of protection of the present application.

What is claimed is:

1. A lens driving device, comprising:
a lens module having an optical axis;
a housing comprising:
a base plate; and
a cover plate disposed on the base plate and forming an accommodating space with the base plate, the cover plate having a light-transmitting hole disposed opposite the lens module;
a first support frame, which is ring-shaped, elastically supported on the base plate, and located within the accommodating space;
a second support frame configured to mount the lens module, elastically supported on and located inside the first support frame at an interval;
a first driving assembly configured to drive the second support frame to move the lens module relative to the first support frame along an axis direction parallel to the optical axis, and comprising a first magnetic circuit system fixed to the first support frame and a driving coil fixed to the second support frame; and
a second driving assembly configured to drive the first support frame to move the second support frame and the lens module relative to the base plate along a direction perpendicular to the axis direction, and comprising a second magnetic circuit system and an anti-vibration coil spaced apart from the second magnetic circuit system, wherein the second magnetic circuit system is fixed to one of the base plate and the first support frame, and the anti-vibration coil is fixed to the other of the base plate and the first support frame;
wherein the upper cover comprises a top wall opposite and spaced apart from the base plate along the axis direction, and a peripheral wall bent and extended from a periphery of the top wall toward the base plate and fixedly connected to the base plate, the periphery of the top wall is provided with a clearance platform recessed toward the base plate along the axis direction.

2. The lens driving device of claim 1, wherein the housing and the first support frame are both rectangular; the clearance platform is located at a corner position of the top wall, and the clearance platform is spaced apart from the first driving assembly along the axis direction.

3. The lens driving device of claim 2, further comprising a damping assembly disposed between the top wall and the first support frame, the top wall is provided with at least two clearance platforms arranged opposite to the damping assembly along the axis direction.

4. The lens driving device of claim 3, further comprising two first driving assemblies correspondingly provided at one set of diagonal positions on the first support frame, the top wall is provided with at least three clearance platforms.

5. The lens driving device of claim 4, further comprising two damping assemblies correspondingly provided at the other set of diagonal positions on the first support frame.

6. The lens driving device of claim 3, wherein the damping assembly comprises a damping adhesive fixed to the first support frame and a damping member fixed to a side of the clearance platform facing the first support frame; and the damping member is inserted into the damping adhesive.

7. The lens driving device of claim 6, wherein a corner position of the first support frame corresponding to the damping assembly is provided with a recess depressed inwardly, and the damping adhesive is accommodated within the recess.

8. The lens driving device of claim 2, further comprising a first elastic member for elastically supporting the second support frame within the first support frame, the first elastic member comprises a first fixing arm fixed to the second support frame, a second fixing arm fixed to the first support frame, and an elastic arm extending from the first fixing arm to be fixedly connected with the second fixing arm, the first elastic member is malposed with the clearance platform along the axis direction.

9. The lens driving device of claim 2, wherein the second magnetic circuit system is fixed to the base plate, the anti-vibration coil is fixed to a side of the first support frame away from the top wall along the axis direction and is opposite to the second magnetic circuit system, the anti-vibration coil and the damping assembly are oppositely arranged along the axis direction.

10. The lens driving device of claim 9, wherein the second driving assembly comprises an anti-collision spacer disposed on a side of the anti-vibration coil facing the second magnetic circuit system, and the anti-collision spacer is spaced apart from the second magnetic circuit system along the axis direction.
